(19) United States
(12) Patent Application Publication
(10) Pub. No.: US 2026/0004211 A1
(43) Pub. Date: Jan. 1, 2026

(54) METHOD AND APPARATUS OF GENERATING PREDICTION INFORMATION, DEVICE, MEDIUM AND PROGRAM PRODUCT

(71) Applicants: Beijing JingDong ShangKe Information Technology Co., Ltd., Beijing (CN); Beijing Wodong Tianjun Information Technology Co., Ltd., Beijing (CN)

(72) Inventors: Jianshen ZHANG, Beijing (CN); Zhengxin SHI, Beijing (CN); Dongyang GENG, Beijing (CN); Yulin HUANG, Beijing (CN); Yongzhi QI, Beijing (CN); Zuojun SHEN, Beijing (CN)

(21) Appl. No.: 18/878,507

(22) PCT Filed: Aug. 8, 2023
(86) PCT No.: PCT/CN2023/111709

§ 371 Date: Dec. 23, 2024

(30) Foreign Application Priority Data
Dec. 6, 2022 (CN) 202211559346.6

(51) Int. Cl. G06Q 10/0631

(52) U.S. Cl. CPC G06Q 10/06315

(57) ABSTRACT

A method and apparatus of generating a prediction information, a device, a medium and a program product are provided. The method includes: acquiring feature data corresponding to a target object for a plurality of object demand influence features; determining an object category corresponding to the target object according to the feature data; determining at least one information to be predicted for the target object according to the object category; generating at least one first feature demand prediction information for a target time according to at least one first feature demand prediction model and the feature data; inputting the at least one first feature demand prediction information and the feature data into a pre-trained second feature demand prediction model, so as to generate at least one second feature demand prediction information and a total demand prediction information for the target time.

### CROSS-REFERENCE TO RELATED APPLICATION(S)

This application is a Section 371 National Stage Application of International Application No. PCT/CN2023/111709, filed on Aug. 8, 2023, entitled “METHOD AND APPARATUS OF GENERATING PREDICTION INFORMATION, DEVICE, MEDIUM AND PROGRAM PRODUCT”, which claims priority to Chinese Patent Application No. 202211559346.6 filed on Dec. 6, 2022, the entire content of which is incorporated herein in its entirety by reference.

### TECHNICAL FIELD

Embodiments of the present disclosure relate to a field of computer technology, and in particular to a method and apparatus of generating a prediction information, a device, a medium and a program product.

### BACKGROUND

At present, object demand prediction has always been a difficult problem in a field of supply chain. For the demand prediction for a target object, a method usually used is to input historical data sequence of the target object into a pre-trained demand prediction neural network, so as to output a demand information for a target time.

However, the inventor found that when using the above method to predict the demand information corresponding to the target object, there are often technical problems as follows.

A prediction process of the demand prediction neural network is not interpretable, leading to a significant risk of replenishment when replenishing using the demand information output by the demand prediction neural network.

The above information disclosed in this background section is only used to enhance the understanding of the background of concepts of the present disclosure, and therefore, it may contain information that does not form the prior art known by those of ordinary skill in the art in the country.

### SUMMARY

The summery section of the present disclosure is intended to introduce concepts in a concise manner, and these concepts will be described in detail below in specific embodiments. The summery section of the present disclosure is not intended to identify key features or essential features of the claimed technical solution, nor is it intended to limit the scope of the claimed technical solution.

Some embodiments of the present disclosure propose a method and apparatus of generating a prediction information, a device, a medium and a program product, to solve the technical problems mentioned in the background section above.

In a first aspect, some embodiments of the present disclosure provide a method of generating a prediction information, including: acquiring feature data corresponding to a target object for a plurality of object demand influence features: determining an object category corresponding to the target object according to the feature data: determining at least one information to be predicted for the target object according to the object category: generating at least one first feature demand prediction information for a target time according to at least one first feature demand prediction model and the feature data, where the at least one first feature demand prediction model is in one-to-one correspondence with the at least one information to be predicted, and the first feature demand prediction model is an interpretable model; and inputting the at least one first feature demand prediction information and the feature data into a pre-trained second feature demand prediction model, so as to generate at least one second feature demand prediction information and a total demand prediction information for the target time, where the second feature demand prediction model is an uninterpretable model.

Optionally, determining at least one information to be predicted for the target object according to the object category includes: determining, in response to determining that the object category is a long-tail object category, a demand trend feature information as an information to be predicted.

Optionally, determining at least one information to be predicted for the target object according to the object category includes: determining, in response to determining that the object category is a first object category, a similar object demand prediction information as an information to be predicted, where an object corresponding to the first object category has no value transfer data.

Optionally, determining at least one information to be predicted for the target object according to the object category includes: determining, in response to determining that the object category is a second object category, a sensitive information corresponding to the target object, where value transfer data of an object corresponding to the second object category meets a preset transfer condition; and determining, in response to determining that the sensitive information indicates that the target object is an object of which a value attribute transformation meets a preset transformation condition, a first value related feature influence information and a demand trend feature information as an information to be predicted respectively.

Optionally, after determining, in response to determining that the sensitive information indicates that the target object is an object of which a value attribute transformation meets a preset transformation condition, a first value related feature influence information and a demand trend feature information as an information to be predicted respectively, the method further includes: determining, in response to determining that the sensitive information indicates that an association degree between value transfer data corresponding to the target object and an object flow information meets a preset association condition, a second value related feature influence information and the demand trend feature information as an information to be predicted respectively.

Optionally, determining at least one information to be predicted for the target object according to the object category includes: determining, in response to determining that the object category is a seasonal object category, a sensitive information corresponding to the target object; and determining, in response to determining that the sensitive information indicates that the target object is an object of which a value attribute transformation meets a preset transformation condition, a first value related feature influence information, a demand trend feature information and a seasonal feature influence information as the information to be predicted respectively.

Optionally, generating at least one first feature demand prediction information for a target time according to at least one first feature demand prediction model and the feature data includes: for each information to be predicted among the at least one information to be predicted, performing a first input step, including: determining, in response to determining that the information to be predicted is a demand trend feature information, demand trend feature data corresponding to the demand trend feature information among the feature data: determining a first feature demand prediction model corresponding to the demand trend feature information as a demand trend information prediction model; and inputting the demand trend feature data into the pre-trained demand trend information prediction model, so as to output a demand trend prediction information as the first feature demand prediction information for the target time.

Optionally, the method further includes: for each information to be predicted among the at least one information to be predicted, performing a second input step, including: determining, in response to determining that the information to be predicted is a first value related feature influence information, first value related feature data corresponding to a first value related feature among the feature data: determining a first feature demand prediction model corresponding to the first value related feature influence information as a first demand information prediction model; and inputting the demand trend prediction information and the first value related feature data into the pre-trained first demand information prediction model, so as to output a first demand prediction information under influence of the first value related feature as the first feature demand prediction information for the target time.

Optionally, the method further includes: for each information to be predicted among the at least one information to be predicted, performing a second input step, including: determining, in response to determining that the information to be predicted is a second value related feature influence information, second value related feature data corresponding to a second value related feature among the feature data: determining a first feature demand prediction model corresponding to the second value related feature influence information as a second demand information prediction model; and inputting the demand trend prediction information and the second value related feature data into the pre-trained second demand information prediction model, so as to output a second demand prediction information under influence of the second value related feature as the first feature demand prediction information for the target time.

Optionally, the method further includes: for each information to be predicted among the at least one information to be predicted, performing a third input step, including: determining, in response to determining that the information to be predicted is a seasonal feature influence information, seasonal feature data corresponding to a seasonal feature among the feature data: determining a first feature demand prediction model corresponding to the seasonal feature influence information as a third demand information prediction model; and inputting the seasonal feature data and the demand trend prediction information into the pre-trained third demand information prediction model, so as to output a third demand prediction information under influence of the seasonal feature as the first feature demand prediction information for the target time.

Optionally, the method further includes: performing replenishment processing on the target object according to the at least one second feature demand prediction information and the total demand prediction information.

In a second aspect, some embodiments of the present disclosure provide an apparatus of generating a prediction information, including: an acquisition unit configured to acquire feature data corresponding to a target object for a plurality of object demand influence features: a first determination unit configured to determine an object category corresponding to the target object according to the feature data: a second determination unit configured to determine at least one information to be predicted for the target object according to the object category: a generation unit configured to generate at least one first feature demand prediction information for a target time according to at least one first feature demand prediction model and the feature data, where the at least one first feature demand prediction model is in one-to-one correspondence with the at least one information to be predicted, and the first feature demand prediction model is an interpretable model; and an input unit configured to input the at least one first feature demand prediction information and the feature data into a pre-trained second feature demand prediction model, so as to generate at least one second feature demand prediction information and a total demand prediction information for the target time, where the second feature demand prediction model is an uninterpretable model.

Optionally, the second determination unit may be configured to determine, in response to determining that the object category is a long-tail object category, a demand trend feature information as the information to be predicted.

Optionally, the second determination unit may be configured to determine, in response to determining that the object category is a first object category, a similar object demand prediction information as the information to be predicted, where an object corresponding to the first object category has no value transfer data.

Optionally, the second determination unit may be configured to determine, in response to determining that the object category is a second object category, a sensitive information corresponding to the target object, where value transfer data of an object corresponding to the second object category meets a preset transfer condition; and determine, in response to determining that the sensitive information indicates that the target object is an object of which a value attribute transformation meets a preset transformation condition, a first value related feature influence information and a demand trend feature information as the information to be predicted respectively.

Optionally, the second determination unit may be configured to determine, in response to determining that the sensitive information indicates that an association degree between value transfer data corresponding to the target object and an object flow information meets a preset association condition, a second value related feature influence information and the demand trend feature information as the information to be predicted respectively.

Optionally, the second determination unit may be configured to determine, in response to determining that the object category is a seasonal object category, a sensitive information corresponding to the target object; and determine, in response to determining that the sensitive information indicates that the target object is an object of which a value attribute transformation meets a preset transformation condition, a first value related feature influence information, a demand trend feature information and a seasonal feature influence information as the information to be predicted respectively.

Optionally, the generation unit may be configured to perform, for each information to be predicted among the at least one information to be predicted, a first input step, including: determining, in response to determining that the information to be predicted is a demand trend feature information, demand trend feature data corresponding to the demand trend feature information among the feature data: determining a first feature demand prediction model corresponding to the demand trend feature information as a demand trend information prediction model; and inputting the demand trend feature data into the pre-trained demand trend information prediction model, so as to output a demand trend prediction information as the first feature demand prediction information for the target time.

Optionally, the generation unit may be configured to perform, for each information to be predicted among the at least one information to be predicted, a second input step, including: determining, in response to determining that the information to be predicted is a first value related feature influence information, first value related feature data corresponding to a first value related feature among the feature data: determining a first feature demand prediction model corresponding to the demand trend feature information as a first demand information prediction model: inputting the demand trend prediction information and the first value related feature data into the pre-trained first demand information prediction model, so as to output a first demand prediction information under influence of the first value related feature as the first feature demand prediction information for the target time.

Optionally, the generation unit may be configured to perform, for each information to be predicted among the at least one information to be predicted, a third input step, including: determining, in response to determining that the information to be predicted is a seasonal feature influence information, seasonal feature data corresponding to a seasonal feature among the feature data: determining a first feature demand prediction model corresponding to the seasonal feature influence information as a third demand information prediction model; and inputting the seasonal feature data and the demand trend prediction information into the pre-trained third demand information prediction model, so as to output a third demand prediction information under influence of the seasonal feature as the first feature demand prediction information for the target time.

Optionally, the apparatus further includes: performing replenishment processing on the target object according to the at least one second feature demand prediction information and the total demand prediction information.

Optionally, the generation unit may be configured to perform, for each information to be predicted among the at least one information to be predicted, a second input step, including: determining, in response to determining that the information to be predicted is a second value related feature influence information, second value related feature data corresponding to a second value related feature among the feature data: determining a first feature demand prediction model corresponding to the second value related feature influence information as a second demand information prediction model; and inputting the demand trend prediction information and the second value related feature data into the pre-trained second demand information prediction model, so as to output a second demand prediction information under influence of the second value related feature as the first feature demand prediction information for the target time.

In a third aspect, some embodiments of the present disclosure provide an electronic device, including: one or more processors: a storage device configured to store one or more programs, where the one or more programs, when executed by the one or more processors, cause the one or more processors to implement the method as described in any one embodiment in the first aspect.

In a fourth aspect, some embodiments of the present disclosure provide a computer readable medium storing a computer program, where the computer program, when executed by a processor, implements the method as described in any one embodiment in the first aspect.

In a fifth aspect, some embodiments of the present disclosure provide a computer program product, including a computer program, where the computer program, when executed by a processor, implements the method as described in any one embodiment in the first aspect.

### BRIEF DESCRIPTION OF THE DRAWINGS

The above and other features, advantages, and aspects of various embodiments of the present disclosure will become more apparent with reference to the following detailed embodiments in conjunction with the accompanying drawings. Throughout the drawings, the same or similar reference numbers represent the same or similar elements. It should be understood that the drawings are schematic and the components and elements are not necessarily drawn to scale.

FIG. 1 and FIG. 2 are schematic diagrams of an application scene of a method of generating a prediction information according to some embodiments of the present disclosure:

FIG. 3 is a flowchart of a method of generating a prediction information according to some embodiments of the present disclosure:

FIG. 4 is a flowchart of a method of generating a prediction information according to some other embodiments of the present disclosure:

FIG. 5 is a schematic diagram of a structure of an apparatus of generating a prediction information according to some embodiments of the present disclosure:

FIG. 6 is a schematic diagram of a structure of an electronic device suitable for implementing some embodiments of the present disclosure.

### DETAILED DESCRIPTION OF EMBODIMENTS

Embodiments of the present disclosure will be described in more detail below with reference to the accompanying drawings. Although the drawings show certain embodiments of the present disclosure, it should be understood that the present disclosure may be implemented in various forms and should not be interpreted as limited to embodiments explained herein. On the contrary, these embodiments are provided to provide a more thorough and complete understanding of the present disclosure. It should be understood that the drawings and embodiments of the present disclosure are only used for illustrative purposes and are not intended to limit the scope of protection of the present disclosure.

It should also be noted that, for convenience of description, only parts related to the present disclosure are shown in the drawings. Without conflict, embodiments in the present disclosure and features in embodiments may be combined with each other.

It should be noted that concepts of “first”, “second”, etc. mentioned in the present disclosure are only used to distinguish different devices, modules, or units, and are not used to limit an order or interdependence of functions performed by these devices, modules, or units.

It should be noted that “one” and “a plurality of” mentioned in the present disclosure is illustrative rather than restrictive. Those skilled in the art should understand that unless otherwise explicitly indicated in the context, they should be understood as “one or more”.

Names of messages or information interacted between a plurality of devices in embodiments of the present disclosure are only for illustrative purposes and are not intended to limit the scope of these messages or information.

Before performing corresponding operations such as collecting, storing and using object data (such as feature data) involved in the present disclosure, related organizations or individuals should fulfill their obligations, including conducting object data security impact evaluations, fulfilling their obligation to inform an object data subject, and obtaining prior authorization and consent from the object data subject.

The present disclosure will be described in detail with reference to the accompanying drawings and in conjunction with embodiments.

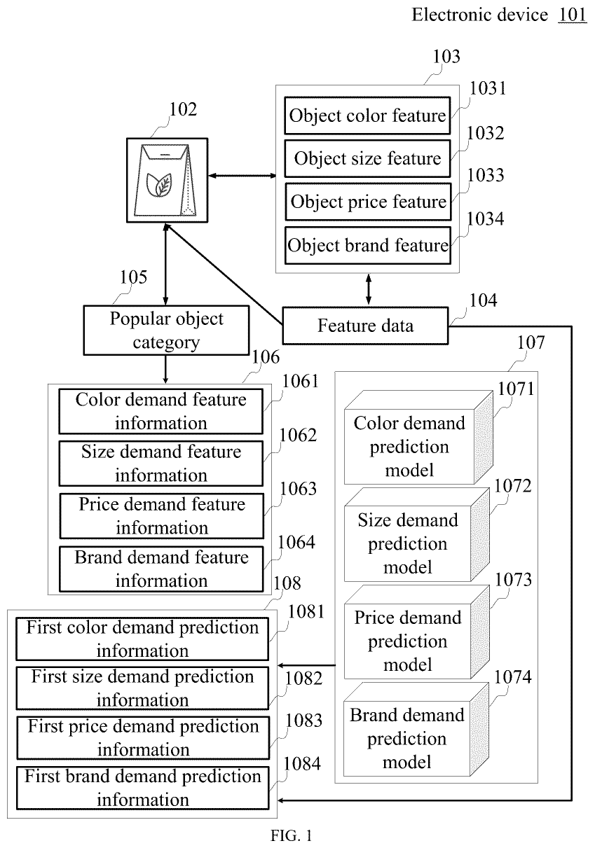

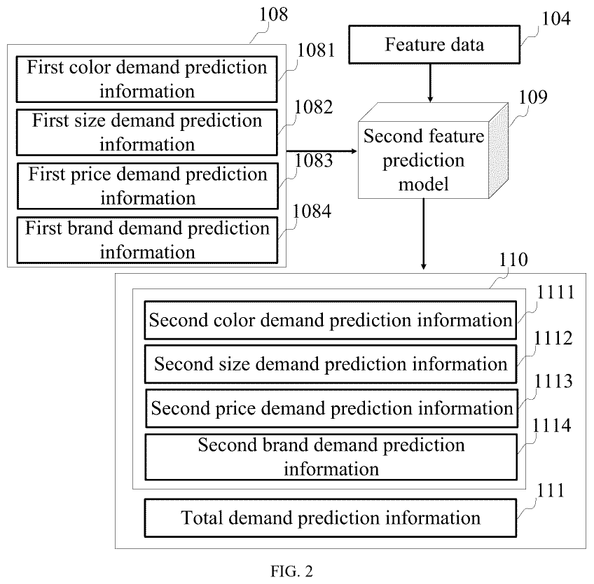

FIG. 1 and FIG. 2 are schematic diagrams of an application scene of a method of generating a prediction information according to some embodiments of the present disclosure.

In the application scene of FIG. 1 and FIG. 2, firstly, an electronic device 101 may acquire feature data 104 corresponding to a target object 102 for a plurality of object demand influence features 103. In this application scene, the target object 102 may be “tea”. The plurality of object demand influence features 103 may include: an object color feature 1031, an object size feature 1032, an object price feature 1033, and an object brand feature 1034. Then, the electronic device 101 may determine an object category 105 corresponding to the target object 102 according to the feature data 104. In this application scene, the object category 105 may be a popular object category. Next, the electronic device 101 may determine at least one information to be predicted 106 for the target object 102 according to the object category 105. In this application scene, the at least one information to be predicted 106 may include: a color demand feature information 1061, a size demand feature information 1062, a price demand feature information 1063, and a brand demand feature information 1064. Furthermore, the electronic device 101 may generate at least one first feature demand prediction information 108 for a target time according to at least one first feature demand prediction model 107 and the feature data 104. The at least one first feature demand prediction model is in one-to-one correspondence with the at least one information to be predicted. The first feature demand prediction model is an interpretable model. In this application scene, the at least one first feature demand prediction model 107 includes a color demand prediction model 1071, a size demand prediction model 1072, a price demand prediction model 1073, and a brand demand prediction model 1074. Finally, the electronic device 101 may input the at least one first feature demand prediction information 108 and the feature data 104 into a pre-trained second feature demand prediction model 109, so as to generate at least one second feature demand prediction information 110 and a total demand prediction information 111 for the target time. The second feature demand prediction model is an uninterpretable model. In this application scene, the at least one second feature demand prediction information 110 includes: a second color demand prediction information 1111, a second size demand prediction information 1112, a second price demand prediction information 1113, and a second brand demand prediction information 1114.

It should be noted that the electronic device 101 may be hardware or software. When the electronic device is hardware, it may be implemented as a distributed cluster formed by a plurality of servers or terminal devices, or as a single server or single terminal device. When the electronic device is implemented as software, it may be installed in the hardware devices listed above. It may be implemented as, for example, a plurality of software or software modules used to provide distributed services, or as a single software or software module, which will not be specifically limited herein.

It should be understood that the number of electronic devices in FIG. 1 is only schematic. Any number of electronic devices may be provided as desired in practice.

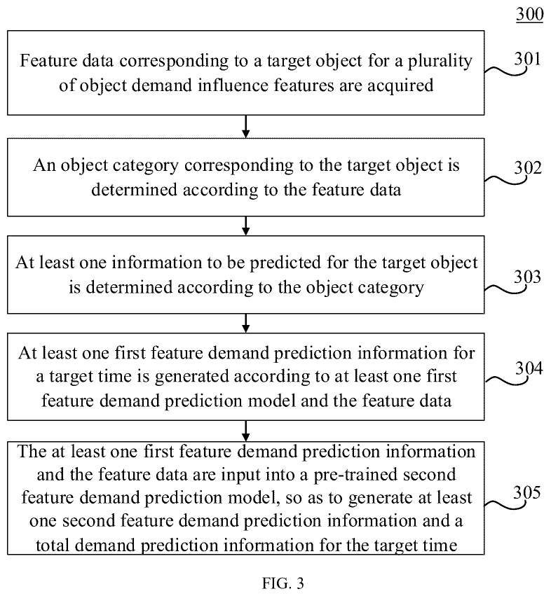

With continued reference to FIG. 3, a flow 300 of some embodiments of a method of generating a prediction information according to the present disclosure is shown. The method of generating a prediction information includes step 301 to step 305.

In step 301, feature data corresponding to a target object for a plurality of object demand influence features are acquired.

In some embodiments, an execution subject of the above-mentioned method of generating a prediction information (such as the electronic device 101 shown in FIG. 1) may acquire the feature data corresponding to the target object for the plurality of object demand influence features through wired or wireless connection. The object demand influence feature may be a feature that has an impact on an object demand. For example, the object demand influence feature may be but is not limited to, at least one of: an object sales volume feature, an object marketing feature, a seasonal feature, and an object promotion feature. The feature data may include: a historical sales volume data set corresponding to the object sales volume feature, a historical marketing data set corresponding to the object marketing feature, a historical seasonal data set corresponding to the seasonal feature, and a historical promotional data set corresponding to the object promotion feature. The historical seasonal data set may be a historical data set of the target object for a predetermined season.

In step 302, an object category corresponding to the target object is determined according to the feature data.

In some embodiments, the execution subject may determine an object category corresponding to the target object according to the feature data. The object category is a category information to which the object belongs. Each object category may be set in advance. In practice, for an intended use of the object, the object category may be, but is not limited to, at least one of: a household appliance object category, a cleaning object category, and an edible object category.

As an example, firstly, the execution subject may perform data vector conversion processing on the above feature data to obtain a feature data vector. Then, the execution subject may input a feature data vector into an object category recognition model to generate the object category corresponding to the target object. The object category recognition model may be a model that identifies the object category. For example, the object category recognition model may be a Convolutional Neural Network (CNN).

In step 303, at least one information to be predicted for the target object is determined according to the object category.

In some embodiments, the execution subject may determine at least one information to be predicted for the target object according to the object category. The information to be predicted may be information that is to be predicted for object information of the target object. In practice, the information to be predicted may be, but is not limited to, at least one of: a demand peak period prediction information, a demand peak value prediction information, and a demand transportation cost prediction information.

As an example, the execution subject may determine at least one information to be predicted for the target object according to the object category through an association table that represents an association between the object category and the information to be predicted.

In some alternative implementations of some embodiments, in response to determining that the object category is a long-tail object category, the execution subject may determine a demand trend feature information as the information to be predicted.

The object corresponding to the long-tail object category is a long-tail object. The demand trend feature information may be a feature information of a demand trend. The demand trend may be changes in demand of the target object.

In some alternative implementations of some embodiments, in response to determining that the object category is a first object category, the execution subject may determine a similar object demand prediction information as the information to be predicted.

An object corresponding to the first object category has no value transfer data. In practice, the first object category may be a new object category. The object corresponding to the new object category may be a newly listed object for sale. The value transfer data may be sales data. That is, there is no sales data for new object. A similar object demand prediction information may be a demand prediction information of an object similar to the target object at a target time.

In some alternative implementations of some embodiments, determining at least one information to be predicted for the target object according to the object category includes operations as follows.

In a first step, in response to determining that the object category is a second object category, the execution subject may determine a sensitive information corresponding to the target object.

Value transfer data of an object corresponding to the second object category meets a preset transfer condition. In practice, the second object category may be a popular object category: The popular object category may be that the corresponding object is a popular object. The preset transfer condition may be that the target object is an object with a sales volume within a first predetermined time period greater than a first number. For example, the first number may be 1000. The first predetermined time period may be from November 1^{st} to November 7^{th}. The sensitive information may be sensitive information that affects the sales volume of the target object. For example, the sensitive information may be holiday information.

In a second step, in response to determining that the sensitive information indicates that the target object is an object of which a value attribute transformation meets a preset transformation condition, the execution subject may determine a first value related feature influence information and a demand trend feature information as an information to be predicted respectively.

In practice, the value attribute transformation may be a price change. The preset transformation condition may be that a price fluctuation of the target object within the second preset time period is greater than a second number. For example, the second number may be 100. The first value related feature influence information may be influence information of promotional activities on the demand for target object.

Optionally, the above step further includes:

in response to determining that the sensitive information indicates that an association degree between value transfer data corresponding to the target object and an object flow information meets a preset association condition, the execution subject may determine a second value related feature influence information and the demand trend feature information as an information to be predicted, respectively.

In practice, the value transfer data corresponding to the target object may be sales volume data of the target object. The object flow information may be an object flow situation of the target object. The association degree between the value transfer data and the object flow information may indicate an association relationship between the object sales volume and the object flow. The preset association condition may be that the target object is an object with a corresponding association degree greater than a preset degree. The second value related feature influence information may be influence information of marketing activities on the demand for target objects.

In some alternative implementations of some embodiments, determining at least one information to be predicted for the target object according to the object category may include steps as follows.

In a first step, in response to determining that the object category is a seasonal object category, the execution subject may determine a sensitive information corresponding to the target object.

The object corresponding to the seasonal object category may be a seasonal object. The seasonal object may be an object of which the demand is greatly affected by seasons.

In a second step, in response to determining that the sensitive information indicates that the target object is an object of which a value attribute transformation meets a preset transformation condition, the execution subject may determine a first value related feature influence information, a demand trend feature information, and a seasonal feature influence information as an information to be predicted, respectively.

The seasonal feature influence information may be influence information of seasonal information on the demand for the target object.

In step 304, at least one first feature demand prediction information for a target time is generated according to at least one first feature demand prediction model and the feature data.

In some embodiments, the execution subject may generate at least one first feature demand prediction information for the target time according to at least one first feature demand prediction model and the feature data. The first feature demand prediction model in the at least one first feature demand prediction model is in one-to-one correspondence with information to be predicted among the at least one information to be predicted. The first feature demand prediction model is an interpretable model. The first feature demand prediction model may be a model that predicts information for the object demand influence feature corresponding to the information to be predicted. For example, the first feature demand prediction model may be a decision tree model or a random forest model. The first feature demand prediction information may be demand information of the target object predicted for the target time under influence of the object demand influence feature.

As an example, the execution subject may input the feature data into the at least one first feature demand prediction model, so as to generate at least one first feature demand prediction information for the target time.

In step 305, the at least one first feature demand prediction information and the feature data are input into a pre-trained second feature demand prediction model, so as to generate at least one second feature demand prediction information and a total demand prediction information for the target time.

In some embodiments, the execution subject may input the at least one first feature demand prediction information and the feature data into a pre-trained second feature demand prediction model, so as to generate at least one second feature demand prediction information and a total demand prediction information for the target time. The second feature demand prediction model is an uninterpretable model. The second feature demand prediction model may not only predict the information for the object demand influence feature corresponding to the information to be predicted (i.e., at least one second feature demand prediction information), but also predict a total demand information of the target object at the target time (i.e., the total demand prediction information). For example, the second feature demand prediction model may be a deep learning neural network model. For example, the second feature demand prediction model may be a convolutional neural network. The target time may be a future time. For example, the current time is November 1^{st}. The target time may be November 2^{nd}.

This implementation method is related to artificial intelligence, and it explicitly displays a prediction process of various feature demand prediction information in a case of ensuring to generate accurate prediction information.

In some alternative implementations of some embodiments, after step 205, the method further includes steps as follows.

The execution subject may perform replenishment processing on the target object according to the at least one second feature demand prediction information and the total demand prediction information.

Various embodiments of the present disclosure have the following beneficial effects: the method of generating a prediction information of some embodiments of the present disclosure explicitly demonstrates the prediction process of various feature demand prediction information in a case of ensuring to generate accurate prediction information. Specifically, the reason for an inability to explicitly demonstrate the prediction process of various feature demand prediction information is that: a network prediction process of a demand prediction neural network is not interpretable, resulting in a significant risk of replenishment when using the demand information output by the demand prediction neural network for replenishment. Based on this, the method of generating a prediction information of some embodiments of the present disclosure first acquires feature data corresponding to the target object for the plurality of object demand influence features. Here, by acquiring feature data for subsequent object classification of the target object, the object category corresponding to the target object may be obtained. In addition, feature data is also used for subsequent generation of feature demand information. Then, according to the feature data, the object category corresponding to the target object may be accurately determined, which is used for subsequently determining the information to be predicted corresponding to the target object. Then, at least one information to be predicted for the target object may be accurately determined according to the object category. Here, the obtained at least one information to be predicted facilitates calling of subsequent models and generation of feature demand prediction information. Furthermore, at least one first feature demand prediction information for the target time may be generated according to at least one first feature demand prediction model and the feature data. The at least one first feature demand prediction model is in one-to-one correspondence with the at least one information to be predicted, and the first feature demand prediction model is an interpretable model. Here, by using at least one feature demand prediction model to generate feature demand prediction information, it is possible to explicitly understand the prediction process of at least one feature demand prediction information. On this basis, the problem of uninterpretable prediction process caused by using only deep learning neural network may be avoided. Finally, the at least one first feature demand prediction information and the feature data are input into a pre-trained second feature demand prediction model, which may accurately generate at least one second feature demand prediction information and a total demand prediction information for the target time. The second feature demand prediction model is an uninterpretable model. Here, for the problem of low prediction accuracy of non-interpretable model, the accuracy of feature demand prediction information and total demand prediction information may be guaranteed through an interpretable model (i.e., the second feature demand prediction model). In summary, by using the interpretable model, the prediction process of feature demand prediction information may be explicitly demonstrated. On this basis, using the uninterpretable model, it may further solve the problem existed in the interpretable model, that is the low accuracy. Therefore, the method of generating a prediction information may explicitly demonstrate the prediction process of various feature demand prediction information in a case of ensuring to generate accurate prediction information.

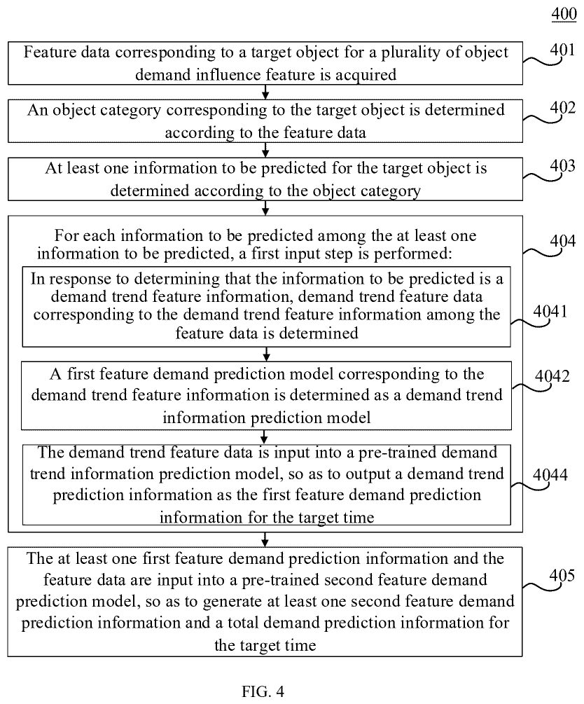

Further referring to FIG. 4, a flow 400 of some other embodiments of the method of generating a prediction information according to the present disclosure is shown. The method of generating a prediction information includes step 401 to step 405.

In step 401, feature data corresponding to a target object for a plurality of object demand influence features is acquired.

In step 402, an object category corresponding to the target object is determined according to the feature data.

In step 403, at least one information to be predicted for the target object is determined according to the object category.

In step 404, for each information to be predicted among the at least one information to be predicted, the following first input step is performed.

In step 4041, in response to determining that the information to be predicted is a demand trend feature information, demand trend feature data corresponding to the demand trend feature information among the feature data is determined.

In some embodiments, in response to determining that the information to be predicted is a demand trend feature information, the execution subject (such as the electronic device 101 shown in FIG. 1) may determine the demand trend feature data corresponding to the demand trend feature information among the feature data. The demand trend feature data may be data related to the demand trend feature.

In step 4042, a first feature demand prediction model corresponding to the demand trend feature information is determined as a demand trend information prediction model.

In some embodiments, the execution subject may determine the first feature demand prediction model corresponding to the demand trend feature information as the demand trend information prediction model. The relationship between the demand trend feature information and the demand trend information prediction model is predetermined.

In practice, the demand trend information prediction model may include a plurality of machine learning models. Each machine learning model has a corresponding weight value.

In step 4043, the demand trend feature data is input into a pre-trained demand trend information prediction model, so as to output a demand trend prediction information as the first feature demand prediction information for the target time.

In some embodiments, the execution subject may input the demand trend feature data into the pre-trained demand trend information prediction model, so as to output the demand trend prediction information as the first feature demand prediction information for the target time.

As an example, firstly, the demand trend information prediction model may include a plurality of machine learning models. Each machine learning model has a corresponding weight value. The execution subject may input the demand trend feature data into the plurality of pre-trained machine learning models, so as to obtain a plurality of output values. Then, the plurality of output values are multiplied by corresponding weights to obtain the first feature demand prediction information for the target time.

In some alternative implementations of some embodiments, after step 404, the method further includes:

for each information to be predicted among the at least one information to be predicted, the following second input step is performed.

In a first step, in response to determining that the information to be predicted is a first value related feature influence information, first value related feature data corresponding to a first value related feature among the feature data is determined.

In practice, the first value related feature may be a promotion feature. The first value related feature data may be promotion feature data.

In a second step, a first feature demand prediction model corresponding to the first value related feature influence information is determined as a first demand information prediction model.

In practice, the first demand information prediction model may be a tree model.

In a third step, the demand trend prediction information and the first value related feature data are input into a pre-trained first demand information prediction model, so as to output a first demand prediction information under influence of the first value related feature as the first feature demand prediction information for the target time.

Here, the first demand information prediction model is a tree model, and by modifying a label learning of the tree model, the model may learn a promotion factor. Based on the promotion factor, the first demand prediction information under influence of the first value related feature may be output.

Optionally, the step further includes:
for each information to be predicted among the at least one information to be predicted, the following second input step is performed.

In a first step, in response to determining that the information to be predicted is a second value related feature influence information, second value related feature data corresponding to a second value related feature among the feature data is determined.

The second value related feature may be a marketing feature. The second value related feature data may be feature data related to marketing activities.

In a second step, a first feature demand prediction model corresponding to the second value related feature influence information is determined as a second demand information prediction model.

In practice, the second demand information prediction model may include equations:

$$R m = \{ \begin{matrix}\frac{{\sum }_{n = k - 1}^{k - 1 + l} {y}_{n}}{{\sum }_{n = k - 1}^{k - 1 + l}} & if y ∈ top sku \\ \frac{{\sum }_{n = k - 1 - w}^{k - 1} {y}_{n}}{{\sum }_{n = k - 1}^{k - 1 + l} {y}_{n}} & if y ∈ other\end{matrix} ,$$

where Rm may be a marketing activity factor, k may represent a K^{th} marketing activity, l may be a duration of the marketing activity, [symbol] may be a demand trend prediction information, yₙ may be a historical sales volume under an n^{th} marketing activity, sku may be a stock keeping unit.

$$= * ( R m - 1 ) ,$$

where [symbol] may be a second demand prediction information.

In a third step, the demand trend prediction information and the second value related feature data are input into the pre-trained second demand information prediction model, so as to output the second demand prediction information under influence of the second value related feature as the first feature demand prediction information for the target time.

Optionally, the step further includes:
for each information to be predicted among the at least one information to be predicted, the following third input step is performed.

In a first step, in response to determining that the information to be predicted is a seasonal feature influence information, seasonal feature data corresponding to a seasonal feature among the feature data is determined.

In practice, the seasonal feature data may be a seasonal feature. The seasonal feature data may be seasonal object data.

In a second step, a first feature demand prediction model corresponding to the seasonal feature influence information is determined as a third demand information prediction model.

In practice, the third demand information prediction model may be a prophet model.

In a third step, the seasonal feature data and the demand trend prediction information are input into a pre-trained third demand information prediction model, so as to output a third demand prediction information under influence of the seasonal feature as the first feature demand prediction information for the target time.

In step 405, the at least one first feature demand prediction information and the feature data are input into a pre-trained second feature demand prediction model, so as to generate at least one second feature demand prediction information and a total demand prediction information for the target time.

In some embodiments, the specific implementation of steps 401 to 403 and 405 and the technical effects thereof may be referred to steps 301 to 303 and 305 in corresponding embodiment of FIG. 3, which will not be repeated here.

It may be seen from FIG. 4, compared to the description of some embodiments corresponding to FIG. 3, the flow 400 of the method of generating a prediction information in some embodiments corresponding to FIG. 4 highlights the specific generation steps for the first feature demand prediction information when the information to be predicted is a demand trend feature information. Thus, the solutions described in these embodiments may accurately generate corresponding first feature demand prediction information with generation process interpretability for demand trend feature information.

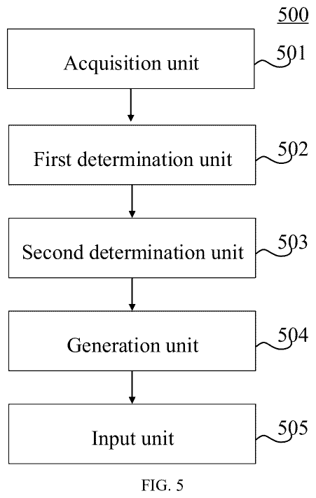

Further referring to FIG. 5, as an implementation of the methods shown in the above figures, the present disclosure provides some embodiments of an apparatus of generating a prediction information, and these apparatus embodiments correspond to those method embodiments shown in FIG. 2. This apparatus of generating a prediction information may be specifically applied to various electronic devices.

As shown in FIG. 5, an apparatus 500 of generating a prediction information includes an acquisition unit 501, a first determination unit 502, a second determination unit 503, a generation unit 504, and an input unit 505. The acquisition unit 501 is configured to acquire feature data corresponding to a target object for a plurality of object demand influence features. The first determination unit 502 is configured to determine an object category corresponding to the target object according to the feature data. The second determination unit 503 is configured to determine at least one information to be predicted for the target object according to the object category. The generation unit 504 is configured to generate at least one first feature demand prediction information for a target time according to at least one first feature demand prediction model and the feature data, where the at least one first feature demand prediction model is in one-to-one correspondence with the at least one information to be predicted, and the first feature demand prediction model is an interpretable model. The input unit 505 is configured to input the at least one first feature demand prediction information and the feature data into a pre-trained second feature demand prediction model, so as to generate at least one second feature demand prediction information and a total demand prediction information for the target time, wherein the second feature demand prediction model is an uninterpretable model.

In some alternative implementations of some embodiments, the second determination unit 503 in the apparatus 500 of generating a prediction information may be further configured to determine a demand trend feature information as the information to be predicted in response to determining that the object category is a long-tail object category.

In some alternative implementations of some embodiments, the second determination unit 503 in the apparatus 500 of generating a prediction information may be further configured to determine a similar object demand prediction information as the information to be predicted in response to determining that the object category is a first object category, where an object corresponding to the first object category has no value transfer data.

In some alternative implementations of some embodiments, the second determination unit 503 in the apparatus 500 of generating a prediction information may be further configured to determine a sensitive information corresponding to the target object in response to determining that the object category is a second object category, where value transfer data of an object corresponding to the second object category meets a preset transfer condition: determine a first value related feature influence information and a demand trend feature information as the information to be predicted respectively, in response to determining that the sensitive information indicates that the target object is an object of which a value attribute transformation meets a preset transformation condition.

In some alternative implementations of some embodiments, the second determination unit 503 in the apparatus 500 of generating a prediction information may be further configured to determine a second value related feature influence information and the demand trend feature information as the information to be predicted respectively, in response to determining that the sensitive information indicates that an association degree between value transfer data corresponding to the target object and an object flow information meets a preset association condition.

In some alternative implementations of some embodiments, the second determination unit 503 in the apparatus 500 of generating a prediction information may be further configured to determine a sensitive information corresponding to the target object in response to determining that the object category is a seasonal object category: determine a first value related feature influence information, a demand trend feature information, and a seasonal feature influence information as the information to be predicted respectively, in response to determining that the sensitive information indicates that the target object is an object of which a value attribute transformation meets a preset transformation condition.

In some alternative implementations of some embodiments, the generation unit 504 in the apparatus 500 of generating a prediction information may be further configured to perform a first input step for each information to be predicted among the at least one information to be predicted: determining, in response to determining that the information to be predicted is a demand trend feature information, demand trend feature data corresponding to the demand trend feature information among the feature data: determining a first feature demand prediction model corresponding to the demand trend feature information as a demand trend information prediction model: inputting the demand trend feature data into the pre-trained demand trend information prediction model, so as to output a demand trend prediction information as the first feature demand prediction information for the target time.

In some alternative implementations of some embodiments, the generation unit 504 in the apparatus 500 of generating a prediction information may be further configured to perform a second input step for each information to be predicted among the at least one information to be predicted: determining, in response to determining that the information to be predicted is a first value related feature influence information, first value related feature data corresponding to a first value related feature among the feature data: determining a first feature demand prediction model corresponding to the demand trend feature information as a first demand information prediction model: inputting the demand trend prediction information and the first value related feature data into the pre-trained first demand information prediction model, so as to output a first demand prediction information under influence of the first value related feature as first feature demand prediction information for the target time.

In some alternative implementations of some embodiments, the generation unit 504 in the apparatus 500 of generating a prediction information may be further configured to perform a second input step for each information to be predicted among the at least one information to be predicted: determining, in response to determining that the information to be predicted is a second value related feature influence information, second value related feature data corresponding to a second value related feature among the feature data: determining a first feature demand prediction model corresponding to the second value related feature influence information as a second demand information prediction model: inputting the demand trend prediction information and the second value related feature data into the pre-trained second demand information prediction model, so as to output a second demand prediction information under influence of the second value related feature as the first feature demand prediction information for the target time.

In some alternative implementations of some embodiments, the generation unit 504 in the apparatus 500 of generating a prediction information may be further configured to perform a third input step for each information to be predicted among the at least one information to be predicted: determining, in response to determining that the information to be predicted is a seasonal feature influence information, seasonal feature data corresponding to a seasonal feature among the feature data: determining a first feature demand prediction model corresponding to the seasonal feature influence information as a third demand information prediction model: inputting the seasonal feature data and the demand trend prediction information into the pre-trained third demand information prediction model, so as to output a third demand prediction information under influence of the seasonal feature as the first feature demand prediction information for the target time.

In some alternative implementations of some embodiments, the apparatus 500 further includes a replenishment unit (not shown in the figure). The replenishment unit may be configured to perform replenishment processing on the target object according to the at least one second feature demand prediction information and the total demand prediction information.

It may be understood that the units described in the apparatus 500 of generating a prediction information correspond to various steps in the method described with reference to FIG. 2. Therefore, the operations, features, and generated beneficial effects described above for the method are also applicable to the apparatus 500 of generating a prediction information and the units contained therein, and are not repeated here.

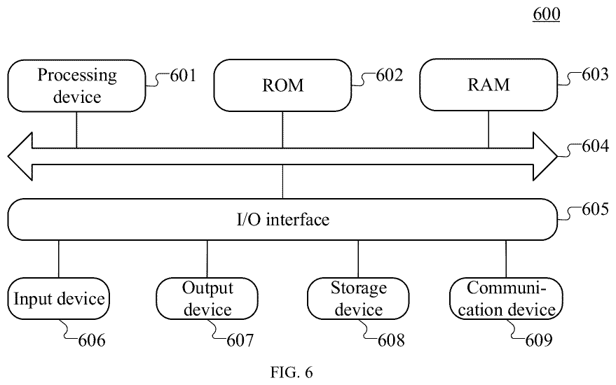

With reference to FIG. 6, a schematic diagram of a structure of an electronic device (such as the electronic device 101 in FIG. 1) 600 suitable for implementing some embodiments of the present disclosure. The electronic device shown in FIG. 6 is only an example, and should not bring any limitations to functions and scope of use of embodiments of the present disclosure.

As shown in FIG. 6, the electronic device 600 may include a processing device (such as a central processing unit, a graphics processor, etc.) 601 that may perform various appropriate actions and processes according to programs stored in a read-only memory 602 or programs loaded from a storage device 608 into a random access memory 603. In the random access memory 603, various programs and data required for the operation of the electronic device 600 are stored. The processing device 601, the read-only memory 602, and the random access memory 603 are connected to each other through a bus 604. An input/output interface 605 is also connected to the bus 604.

Generally, the following devices may be connected to the I/O interface 605: an input device 606 including, for example, a touch screen, a touchpad, a key board, a mouse, a camera, a microphone, an accelerometer, a gyroscope, etc.: an output device 607 including, for example, a liquid crystal display (LCD), a speaker, a vibrator, etc.: a storage device 608 including, for example, a magnetic tape, a hard disk, etc.; and a communication device 609. The communication device 609 may allow the electronic device 600 to perform wireless or wired communication with other devices to exchange data. Although FIG. 6 illustrates an electronic device 600 having various apparatuses, it should be understood that it is not required to implement or have all of the illustrated apparatuses, and it may alternatively be implemented or have more or fewer apparatuses. Each block shown in FIG. 6 may represent a device, or a plurality of devices as desired.

In particular, according to some embodiments of the present disclosure, the process described above with reference to the flowchart may be implemented as a computer software program. For example, some embodiments of the present disclosure include a computer program product including a computer program carried on a computer readable medium. The computer program includes program code for executing the method shown in the flowchart. In such some embodiments, the computer program may be downloaded and installed from the network via the communication device 609, or installed from the storage device 608, or installed from the read-only memory 602. When the computer program is executed by the processing device 601, the above functions defined in the methods of some embodiments of the present disclosure are executed.

It should be noted that the computer readable medium of some embodiments of the present disclosure may be a computer readable signal medium or a computer readable storage medium, or any combination of the two. The computer readable storage medium may be, for example, but is not limited to, an electrical, magnetic, optical, electromagnetic, infrared, or semiconductor system, apparatus, or device, or any combination of the above. More specific examples of the computer readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In some embodiments of the present disclosure, the computer readable storage medium may be any tangible medium that contains or stores a program, and the program may be used by or in conjunction with an instruction execution system, apparatus, or device. In some embodiments of the present disclosure, the computer readable signal medium may include a data signal propagated in the baseband or as part of a carrier wave, which carries computer-readable program code. Such propagated data signals may take a variety of forms, including but not limited to electromagnetic signals, optical signals, or any suitable combination of the above. The computer readable signal medium may also be any computer readable medium other than a computer readable storage medium, and the computer readable storage medium may send, propagate, or transmit programs for use by or in conjunction with an instruction execution system, apparatus, or device. The program code contained on the computer readable medium may be transmitted using any suitable medium, including but not limited to: wire, optical cable, RF (radio frequency), etc., or any suitable combination of the above.

In some embodiments, the client and server may communicate using any currently known or future developed network protocol such as HTTP (Hyper Text Transfer Protocol), and may be interconnected with any form or medium of digital data communication (e.g., communication network). Examples of communication networks include a local area network (“LAN”), a wide area network (“WAN”), the Internet (e.g., the Internet), and a peer-to-peer network (e.g., ad hoc peer-to-peer network), as well as any currently known or future developed network.

The computer readable medium may be included in the electronic device, and it may also exist independently and not be integrated into the electronic device. The computer readable medium carries one or more programs, where that one or more programs, when executed by the electronic device, cause the electronic device to acquire feature data corresponding to the target object for the plurality of object demand influence feature: determine the object category corresponding to the target object according to the feature data: determine at least one information to be predicted for the target object according to the object category: generate at least one first feature demand prediction information for a target time according to at least one first feature demand prediction model and the feature data, where the first feature demand prediction model is in one-to-one correspondence with the information to be predicted, and the first feature demand prediction model is an interpretable model: input the at least one first feature demand prediction information and the feature data into a pre-trained second feature demand prediction model, so as to generate at least one second feature demand prediction information and a total demand prediction information for the target time, where the second feature demand prediction model is an uninterpretable model.

Computer program code for performing operations of some embodiments of the present disclosure may be written in one or more programming languages or combinations thereof, including object-oriented programming languages such as Java, Smalltalk, C++, as well as conventional procedural programming languages such as the “C” language or similar programming languages. The program code may be executed entirely on the user's computer, partially on the user's computer, as a standalone software package, partially on the user's computer and partially on a remote computer, or entirely on a remote computer or server. In cases involving remote computers, the remote computer may be connected to the user's computer via any type of network, including a local area network (LAN) or a wide area network (WAN), or it may be connected to an external computer (such as by utilizing an Internet service provider to connect via the Internet).

The flowchart and block diagram in the accompanying drawings illustrate the possible implementation architecture, functions, and operations of systems, methods, and computer program products according to various embodiments of the present disclosure. In this regard, each block in a flowchart or block diagram may represent a module, program segment, or a part of code, and the module, the program segment, or the part of code contains one or more executable instructions for implementing a specified logical function. It should also be noted that in some alternative implementations, the functions indicated in the blocks may also occur in an order different from the order indicated in the figures. For example, two blocks represented in succession may actually be substantially executed in parallel, and they may sometimes be executed in reverse order, depending on the functions involved. It should also be noted that each block in the block diagram and/or flowchart, as well as combinations of blocks in the block diagram and/or flowchart, may be implemented using a dedicated hardware-based system that performs the specified functions or operations, or may be implemented using a combination of dedicated hardware and computer instructions.

Units described in some embodiments of the present disclosure may be implemented in software or hardware. The described unit may also be integrated into a processor. For example, it may be described as a processor including an acquisition unit, a first determination unit, a second determination unit, a generation unit, and an input unit. Names of these units do not constitute a limitation on the units themselves in some cases. For example, the acquisition unit may also be described as “a unit that acquires feature data corresponding to a target object for a plurality of object demand influence features”.

Functions described above in this text may be executed at least partially by one or more hardware logic components. For example, without limitation, exemplary types of hardware logic components that may be used include a field programmable gate array (FPGA), an application specific integrated circuits (ASIC), an application specific standard products (ASSP), a system-on-chip (SOC), a complex programmable logic devices (CPLD), and the like.

Some embodiments of the present disclosure further provide a computer program product, including a computer program, where the computer program, when executed by a processor implements any of the above-mentioned method of generating a prediction information.

The above description is only some preferred embodiments of the present disclosure and an explanation of technical principles applied. Those skilled in the art should understand that the scope of the invention involved in embodiments of the present disclosure is not limited to the technical solutions formed by specific combinations of the above technical features, but also includes other technical solutions formed by any combination of the above technical features or their equivalent features without departing from the above inventive concept. For example, the other technical solutions may be formed by replacing the above features with the technical features disclosed in the embodiments of the present disclosure (but not limited to) with similar functions.

1. A method of generating a prediction information, comprising:
acquiring feature data corresponding to a target object for a plurality of object demand influence features;
determining an object category corresponding to the target object according to the feature data;
determining at least one information to be predicted for the target object according to the object category;
generating at least one first feature demand prediction information for a target time according to at least one first feature demand prediction model and the feature data, wherein the at least one first feature demand prediction model is in one-to-one correspondence with the at least one information to be predicted, and the first feature demand prediction model is an interpretable model; and
inputting the at least one first feature demand prediction information and the feature data into a pre-trained second feature demand prediction model, so as to generate at least one second feature demand prediction information and a total demand prediction information for the target time, wherein the second feature demand prediction model is an uninterpretable model.

2. The method of claim 1, wherein determining at least one information to be predicted for the target object according to the object category comprises:
determining, in response to determining that the object category is a long-tail object category, a demand trend feature information as an information to be predicted.

3. The method of claim 1, wherein determining at least one information to be predicted for the target object according to the object category comprises:
determining, in response to determining that the object category is a first object category, a similar object demand prediction information as an information to be predicted, wherein an object corresponding to the first object category has no value transfer data.

4. The method of claim 1, wherein determining at least one information to be predicted for the target object according to the object category comprises:
determining, in response to determining that the object category is a second object category, a sensitive information corresponding to the target object, wherein value transfer data of an object corresponding to the second object category meets a preset transfer condition; and
determining, in response to determining that the sensitive information indicates that the target object is an object of which a value attribute transformation meets a preset transformation condition, a first value related feature influence information and a demand trend feature information as an information to be predicted respectively.

5. The method of claim 4, wherein after determining, in response to determining that the sensitive information indicates that the target object is an object of which a value attribute transformation meets a preset transformation condition, a first value related feature influence information and a demand trend feature information as an information to be predicted respectively, the method further comprises:
determining, in response to determining that the sensitive information indicates that an association degree between value transfer data corresponding to the target object and an object flow information meets a preset association condition, a second value related feature influence information and the demand trend feature information as an information to be predicted respectively.

6. The method of claim 1, wherein determining at least one information to be predicted for the target object according to the object category comprises:
determining, in response to determining that the object category is a seasonal object category, a sensitive information corresponding to the target object; and
determining, in response to determining that the sensitive information indicates that the target object is an object of which a value attribute transformation meets a preset transformation condition, a first value related feature influence information, a demand trend feature information and a seasonal feature influence information as an information to be predicted respectively.

7. The method of claim 1, wherein generating at least one first feature demand prediction information for a target time according to at least one first feature demand prediction model and the feature data comprises:
for each information to be predicted among the at least one information to be predicted, performing a first input step, comprising:
determining, in response to determining that the information to be predicted is a demand trend feature information, demand trend feature data corresponding to the demand trend feature information among the feature data;
determining a first feature demand prediction model corresponding to the demand trend feature information as a demand trend information prediction model; and
inputting the demand trend feature data into the demand trend information prediction model pre-trained, so as to output a demand trend prediction information as a first feature demand prediction information for the target time.

8. The method of claim 7, further comprising:
for each information to be predicted among the at least one information to be predicted, performing a second input step, comprising:
determining, in response to determining that the information to be predicted is a first value related feature influence information, first value related feature data corresponding to a first value related feature among the feature data;
determining a first feature demand prediction model corresponding to the first value related feature influence information as a first demand information prediction model; and
inputting the demand trend prediction information and the first value related feature data into the first demand information prediction model pre-trained, so as to output a first demand prediction information under influence of the first value related feature as a first feature demand prediction information for the target time.

9. The method of claim 7, further comprising:
for each information to be predicted among the at least one information to be predicted, performing a second input step, comprising:
determining, in response to determining that the information to be predicted is a second value related feature influence information, second value related feature data corresponding to a second value related feature among the feature data;
determining a first feature demand prediction model corresponding to the second value related feature influence information as a second demand information prediction model; and
inputting the demand trend prediction information and the second value related feature data into the second demand information prediction model pre-trained, so as to output a second demand prediction information under influence of the second value related feature as a first feature demand prediction information for the target time.

10. The method of claim 7, further comprising:
for each information to be predicted among the at least one information to be predicted, performing a third input step, comprising:
determining, in response to determining that the information to be predicted is a seasonal feature influence information, seasonal feature data corresponding to a seasonal feature among the feature data;
determining a first feature demand prediction model corresponding to the seasonal feature influence information as a third demand information prediction model; and
inputting the seasonal feature data and the demand trend prediction information into the third demand information prediction model pre-trained, so as to output a third demand prediction information under influence of the seasonal feature as a first feature demand prediction information for the target time.

11. The method of claim 1, wherein the method further comprises:
performing replenishment processing on the target object according to the at least one second feature demand prediction information and the total demand prediction information.

12. (canceled)

13. An electronic device, comprising:
one or more processors; and
a storage device configured to store one or more programs,
wherein the one or more programs, when executed by the one or more processors, cause the one or more processors to at least perform operations of:
acquiring feature data corresponding to a target object for a plurality of object demand influence features;
determining an object category corresponding to the target object according to the feature data;
determining at least one information to be predicted for the target object according to the object category;
generating at least one first feature demand prediction information for a target time according to at least one first feature demand prediction model and the feature data, wherein the at least one first feature demand prediction model is in one-to-one correspondence with the at least one information to be predicted, and the first feature demand prediction model is an interpretable model; and
inputting the at least one first feature demand prediction information and the feature data into a pre-trained second feature demand prediction model, so as to generate at least one second feature demand prediction information and a total demand prediction information for the target time, wherein the second feature demand prediction model is an uninterpretable model.

14. A non-transitory computer readable medium storing a computer program, wherein the computer program, when executed by a processor, at least performs operations of:
acquiring feature data corresponding to a target object for a plurality of object demand influence features;
determining an object category corresponding to the target object according to the feature data;
determining at least one information to be predicted for the target object according to the object category;
generating at least one first feature demand prediction information for a target time according to at least one first feature demand prediction model and the feature data, wherein the at least one first feature demand prediction model is in one-to-one correspondence with the at least one information to be predicted, and the first feature demand prediction model is an interpretable model; and
inputting the at least one first feature demand prediction information and the feature data into a pre-trained second feature demand prediction model, so as to generate at least one second feature demand prediction information and a total demand prediction information for the target time, wherein the second feature demand prediction model is an uninterpretable model.

15. (canceled)

16. The electronic device of claim 13, wherein the one or more processors are further configured to perform operations of:
determining, in response to determining that the object category is a long-tail object category, a demand trend feature information as an information to be predicted.

17. The electronic device of claim 13, wherein the one or more processors are further configured to perform operations of:
determining, in response to determining that the object category is a first object category, a similar object demand prediction information as an information to be predicted, wherein an object corresponding to the first object category has no value transfer data.

18. The electronic device of claim 13, wherein the one or more processors are further configured to perform operations of:
determining, in response to determining that the object category is a second object category, a sensitive information corresponding to the target object, wherein value transfer data of an object corresponding to the second object category meets a preset transfer condition; and
determining, in response to determining that the sensitive information indicates that the target object is an object of which a value attribute transformation meets a preset transformation condition, a first value related feature influence information and a demand trend feature information as an information to be predicted respectively.

19. The electronic device of claim 18, wherein the one or more processors are further configured to perform operations of:
determining, in response to determining that the sensitive information indicates that an association degree between value transfer data corresponding to the target object and an object flow information meets a preset association condition, a second value related feature influence information and the demand trend feature information as an information to be predicted respectively.

20. The electronic device of claim 13, wherein the one or more processors are further configured to perform operations of:
determining, in response to determining that the object category is a seasonal object category, a sensitive information corresponding to the target object; and
determining, in response to determining that the sensitive information indicates that the target object is an object of which a value attribute transformation meets a preset transformation condition, a first value related feature influence information, a demand trend feature information and a seasonal feature influence information as an information to be predicted respectively.

21. The electronic device of claim 13, wherein the one or more processors are further configured to perform operations of:
for each information to be predicted among the at least one information to be predicted, performing a first input step, comprising:
determining, in response to determining that the information to be predicted is a demand trend feature information, demand trend feature data corresponding to the demand trend feature information among the feature data;
determining a first feature demand prediction model corresponding to the demand trend feature information as a demand trend information prediction model; and
inputting the demand trend feature data into the demand trend information prediction model pre-trained, so as to output a demand trend prediction information as a first feature demand prediction information for the target time.

22. The electronic device of claim 21, wherein the one or more processors are further configured to perform operations of:
for each information to be predicted among the at least one information to be predicted, performing a second input step, comprising:
determining, in response to determining that the information to be predicted is a first value related feature influence information, first value related feature data corresponding to a first value related feature among the feature data;
determining a first feature demand prediction model corresponding to the first value related feature influence information as a first demand information prediction model; and
inputting the demand trend prediction information and the first value related feature data into the first demand information prediction model pre-trained, so as to output a first demand prediction information under influence of the first value related feature as a first feature demand prediction information for the target time.
